(19) United States
(12) Patent Application Publication
(10) Pub. No.: US 2014/0164513 A1
(43) Pub. Date: Jun. 12, 2014

(54) MOBILE DEVICE APPLICATION FOR DELIVERING NOTIFICATIONS FOR VIEWERS' ACCESS TO PRESENTATIONS

(71) Applicant: CLEARSIDE, INC., San Francisco, CA (US)

(72) Inventors: Adam Michael Lieb, San Francisco, CA (US); Stefano Acerbetti, San Francisco, CA (US)

(73) Assignee: Clearside, Inc., San Francisco, CA (US)

(21) Appl. No.: 13/844,220

(22) Filed: Mar. 15, 2013

Related U.S. Application Data
(60) Provisional application No. 61/736,518, filed on Dec. 12, 2012.

(51) Int. Cl. H04L 29/08

(52) U.S. Cl. CPC H04L 67/22
USPC 709/204

(57) ABSTRACT

Techniques are disclosed for delivering and receiving notifications regarding information about viewers' access to such presentations over a communications network (e.g., the Internet). An example method comprises tracking, by a presentation server, access of a link to a presentation by a viewer, wherein the presentation is stored on the presentation server and associated with a presenter; and sending a first push notification to a mobile device of the presenter based on data resulting from the tracking. Among other benefits, some embodiments disclosed herein provide both the convenience of allowing the viewer to view the presentation at his or her own time and similar high responsiveness the live presentation can bring.

### CROSS-REFERENCE TO RELATED APPLICATIONS

This application claims priority to and the benefit of U.S. Provisional Application No. 61/736,518, entitled “MOBILE DEVICE APPLICATION FOR DELIVERING NOTIFICATIONS FOR VIEWERS' ACCESS TO PRESENTATIONS”, filed Dec. 12, 2012, which is incorporated by reference herein.

### TECHNICAL FIELD

The present disclosure relates to remote, computerized presentation of sales and/or other information, and more specifically, to methods and apparatuses for delivering and receiving notifications regarding information about viewers' access to such presentations over a communications network (e.g., the Internet).

### BACKGROUND

Typically, computerized presentation (e.g., a Powerpoint presentation) requires a presentation file to be stored on a local computer and requires particular software (e.g., Microsoft Powerpoint) compatible with the presentation file to be installed on the computer in order to display the presentation properly. This process generally needs to be performed ahead of time at a location where the computer is physically located before any presentation can be made.

It is useful for a presenter to be able to perform a presentation over a network to one or more viewers. A presenter can upload presentations to a presentation server for storage. Subsequently, the presentation may be delivered as a live presentation, where the presenter may start by providing to viewers a viewer link (e.g., a worldwide web URL) that uniquely identifies the presenter, and when a viewer accesses the link, the viewer automatically sees a presentation slide as selected by the presenter. This may be useful if both the presenter's and the viewer's availability coincide in time. As an alternative, the presenter can send a link (e.g., via email) to the presentation to a viewer recipient for the recipient to view, on the presentation server, at any time of his or her choice.

### BRIEF DESCRIPTION OF DRAWINGS

The present embodiments are illustrated by way of example and are not intended to be limited by the figures of the accompanying drawings. In the drawings:

FIG. 1A depicts a diagram of an exemplary environment where a presentation server provides delivery of a stored presentation over a network, such as the Internet;

FIG. 1B depicts a simplified functional diagram of the presenter's mobile computing device of FIG. 1A with an mobile device application installed on the device in accordance with some embodiments;

FIG. 2 depicts a flowchart illustrating an example process of delivering notifications for viewers' access to presentations from a presentation server to a mobile device;

FIG. 3 depicts a flowchart illustrating an example process of receiving notifications for viewers' access to presentations from a presentation server at a mobile device; and

FIG. 4 depicts a block diagram showing an example of the architecture for a system in which the present embodiments may be implemented.

The same reference numbers and any acronyms identify elements or acts with the same or similar structure or functionality throughout the drawings and specification for ease of understanding and convenience.

### DETAILED DESCRIPTION

Techniques are disclosed for delivering and receiving notifications regarding information about viewers' access to such presentations over a communications network (e.g., the Internet). An example method comprises tracking, by a presentation server, access of a link to a presentation by a viewer, wherein the presentation is stored on the presentation server and associated with a presenter; and sending a first push notification to a mobile device of the presenter based on data resulting from the tracking. Another example method comprises receiving, on a mobile device of a presenter, a notification from a presentation server regarding a viewer's access to a presentation associated with the presenter via a link, wherein the presentation is stored on the presentation server, and wherein the notification is triggered by the viewer accessing the link and includes contact information of the viewer; and triggering, on the mobile device, a communication interface to allow the presenter to contact the viewer based on the received contact information. Among other benefits, some embodiments disclosed herein provide both the convenience of allowing the viewer to view the presentation at his or her own time and similar high responsiveness the live presentation can bring.

Various examples of the present disclosure will now be described. The following description provides specific details for a thorough understanding and enabling description of these examples. One skilled in the relevant art will understand, however, that the embodiments disclosed herein may be practiced without many of these details. Likewise, one skilled in the relevant art will also understand that the present embodiments may include many other obvious features not described in detail herein. Additionally, some well-known methods, procedures, structures or functions may not be shown or described in detail below, so as to avoid unnecessarily obscuring the relevant description.

The techniques disclosed below are to be interpreted in their broadest reasonable manner, even though they are being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

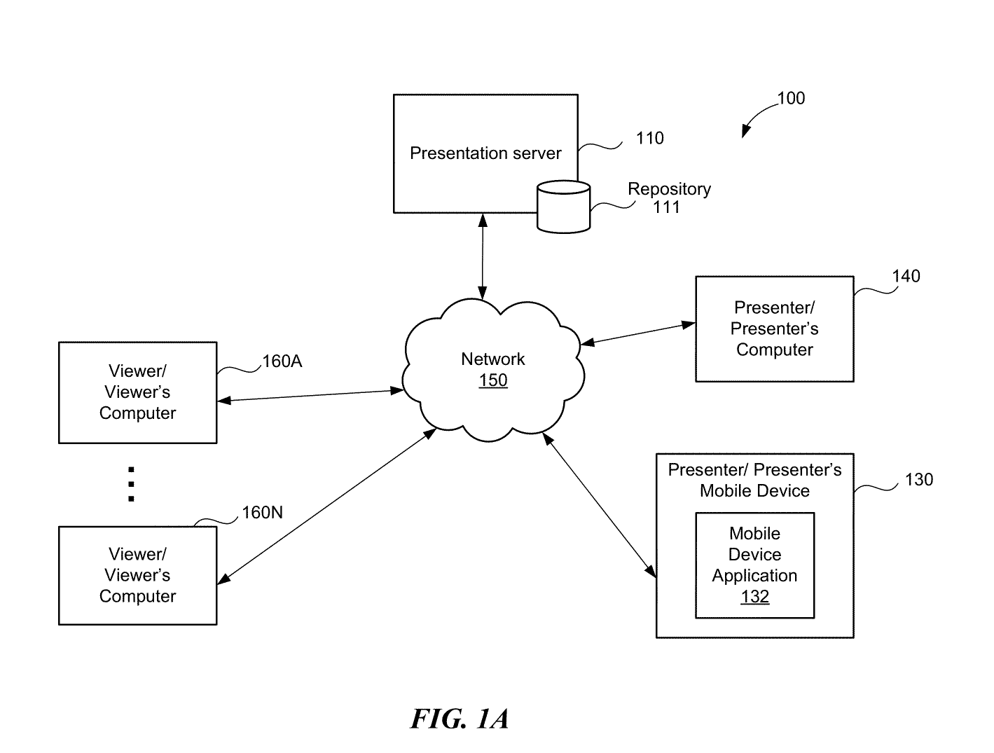

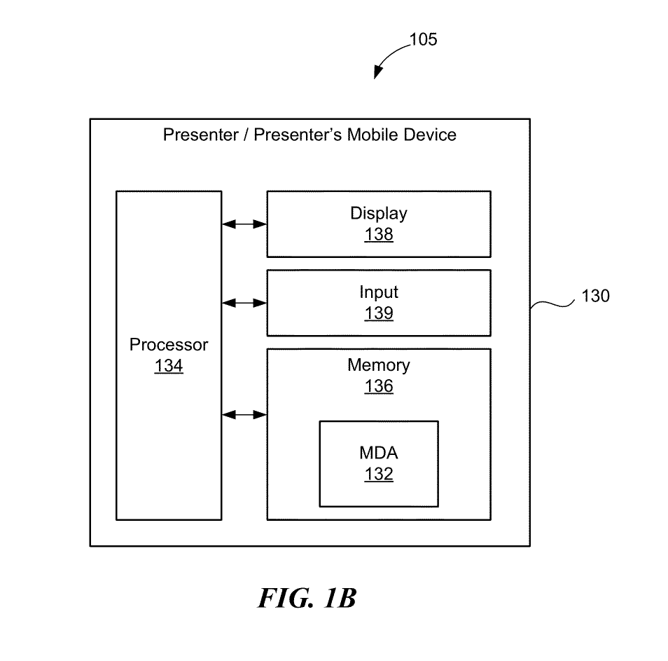

FIG. 1A depicts a diagram of an exemplary environment 100 where a presentation server 110 provides delivery of a stored presentation in a repository 111 over a network 150, such as the Internet, to one or more viewers 160A-160N. The environment 100 includes a presenter operating a presenter computer 140 and/or a presenter mobile computing device (MCD) 130, one or more viewers operating viewer devices 160A-160N, a presentation server 110, and a network 150.

The MCD 130, the presenter device 140 and the viewer devices 160A-160N can be any system and/or device, and/or any combination of devices/systems that is able to establish a connection, including wired, wireless, cellular connections with another device, a server and/or other systems such as presentation server 110. The MCD 130, viewer devices 160 and presenter device 140 typically include a display and/or other output functionalities to present information and data exchanged between or among the devices 130, 140, 160 and/or the presentation server 110. In one embodiment, there is only a single presentation server 110. In one embodiment, there are multiple presentation servers 110 operating independently.

The viewer devices 160 and the presenter device 140 may include general computing devices and may be any of, but not limited to, a server desktop, a desktop computer, a computer cluster, a notebook, or a laptop computer. The MCD 130 may include mobile, hand held, or portable devices, and may be any of, but not limited to, a handheld computer, a palmtop computer, a mobile phone, a cell phone, a smart phone, a PDA, a Blackberry device, a Treo, a handheld tablet (e.g., an iPad, a Galaxy, Xoom Tablet, etc.), a tablet PC, a thin-client device, a hand held console, a hand held gaming device or console, an iPhone, and/or any other portable, mobile, hand held devices, etc. In one example, the MCD 130, the viewer devices 160, presentation server 110, and presenter's device 140 are coupled via the network 150. In some other examples, the devices 130, 140, 160 and presentation server 110 may be directly connected to one another.

FIG. 1B depicts a simplified functional diagram 105 of the presenter's mobile computing device (MCD) 130 of FIG. 1A with a mobile device application (MDA) 132 installed on the device 130 in accordance with some embodiments. The device 130 includes a processor component 134, a memory component 136, a display screen 138, and one or more input mechanisms 139.

Memory component 136 can be any suitable memory element or device including, for example, DRAM, SRAM, ROM, EEPROM and/or Flash memory. Processor component 134 can be any suitable processor capable of executing scripts or instructions of one or more software programs stored, for example, in memory component 136. Although not shown in FIG. 1B for simplicity, MCD 130 can also include a well-known cache memory that stores frequently used instructions and/or data.

The display screen 138 may include one or more display monitors suitable for displaying various symbols and information, and may include a touch-screen control layer which would also function as an input mechanism. The input mechanism 139 on MCD 130 can include, but is not limited to, a touch screen keypad (including single touch, multi-touch, gesture sensing in 2D or 3D, etc.), a physical keypad, a keyboard, one or more actuatable buttons, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

A presenter 140 can upload a presentation to the presentation server 110 for storage, and then the presenter 140 or any viewer 160A, 160N can access the presentation over the network 150 from any computer that connects to an appropriate web link. Each presentation uploaded is called a “presentation deck,” which may contain one or more slides inside the presentation deck. The slides of the presentation deck can each embed different types of media including, but not limited to, a Powerpoint slide, a live webpage, PDF documents, and videos. The presentation server 110 is described in more detail in U.S. patent application Ser. No. 12/756,145, entitled “PRESENTATION ACCESS TRACKING SYSTEM,” filed Apr. 7, 2010, and is incorporated herein in its entirety.

In one mode, the presenter can make a “live presentation” to one or more viewers 160A, 160N remotely. The presenter 140 can access his presentation on the presentation server 110 and send a viewer link (e.g., an URL) for the live presentation to one or more viewers 160A, 160N. When those viewers 160A, 160N access the viewer link (e.g., via a web browser) using a client device, they can automatically see the slides (e.g., as provided within the web browser by the presentation server 110) of the presentation as the presenter 140 selects each slide for display (in a synchronous way). Moreover, the presenter 140 is not limited to the slides from a single presentation. The presenter can select slides from different stored presentations for the live presentation. In the live presentation mode, the presentation server 110 can also track data related to the live pitch, similar to the tracked data for viewers independently viewing a presentation. The analytic data for each presentation, whether delivered as a live presentation or viewed by a viewer independently, is available to the presenter 140 to review through the presentation server 110.

In another mode, the presenter 140 can send a web link (e.g., via an email) to the presentation stored on the presentation server 110 to one or more recipients 160A, 160N for viewing whenever the recipients want (i.e., in an asynchronous way, not controlled by the presenter 140). The presentation server 110 tracks data related to the recipients' access of the presentation including, but not limited to, when each recipient 160A, 160N views the presentation, how long each recipient 160A, 160N views each slide of the presentation, whether any of the recipients 160A, 160N forwarded the link to the presentation to other viewers, and to whom the link to the presentation was forwarded. Similarly, when subsequent viewers of the presentation access the presentation using the link, the presentation server 110 also tracks viewing data related to subsequent viewers.

The embodiments disclosed herein recognize that performing an asynchronous presentation without the need of matching the presenter's and the viewer's availability is useful, especially when the presentation is a sales pitch where the viewer may want to enjoy the feeling of more control over his or her time. Further, the embodiments disclosed herein recognize that one of the benefits from performing a synchronous, live presentation is the high responsiveness, which may increase the effectiveness for situations like a sales pitch and thus be desirable.

Specifically, once the email with the web link has been sent by the presenter 140 to one or more viewers 160A, 160N, it would be advantageous for the presenter 140 to be notified when a viewer accesses the presentation, how long the viewer is accessing which slide of the presentation, which viewer is accessing the presentation, and when a viewer leaves a comment on the presentation. The presenter 140 can use the notifications to quickly follow up with a call or email to the viewer while the presentation is fresh in the viewer's mind, or even to call the viewer while he is viewing the presentation to further reinforce the content of the presentation or answer any questions if the viewer is spending a long time on a particular slide.

According to the embodiments disclosed herein, the mobile device application (MDA) 132 and the presentation server 110 can respectively receive and deliver push notifications about when a viewer (e.g., viewer 160A) accesses a link (e.g., inside an email sent by the presenter 140) to a presentation stored on the presentation server 110. The push notifications may provide information to the presenter 140, who emailed the link to the viewer 160A, regarding contact information for the viewer 160A and viewer access data, such as how long the viewer 160A viewed each slide of the presentation.

Depending on the embodiments, the presenter 140 may first log into the presentation server 110 via the MDA 132 on the MCD 130 to enable the push notification functions. Then the MDA 132 can receive push notifications from the presentation server 110 via the MCD 130 when the presentation server 110 tracks the viewer 160A accessing an emailed presentation link. As discussed above, the presentation server 110 is able to automatically track data pertaining to viewer access to linked presentations. Thus, once the viewer 160A loads the emailed link to access the presentation stored on the presentation server 110, the presentation server 110 starts to receives information about the viewer 160A's access.

Then, the server 110 automatically sends out a first push notification to the MDA 132 on the MCD 130 to notify the presenter 140 of the viewer 160A's access based on data resulting from the tracking. In one embodiment, the first push notification is triggered upon the access, so that once the viewer 160A opens the presentation, the presenter 140 is immediately notified by the first push notification via the MDA 132 on his or her MCD 130. The first push notification can include the presentation being viewed, the time the viewer 160A started accessing the presentation, and may include the identity and/or the contact information of the viewer 160A, such as email address and/or telephone number. In this way, after the MDA 132 receives the push notification(s) from the presentation server 110, the MDA 132 can trigger a communication interface (e.g., a telephone or an email interface, not shown in FIG. 1B for simplicity) on the MCD 130 to prompt the presenter 140 to contact the viewer 160A based on the contact information received from the push notification(s).

As the viewer accesses each slide in the presentation, the presentation server 110 can provide via the MDA 132 subsequent push notifications with analytic data updates, such as how long the user accessed each slide. Further, the presentation server 110 can provide a close push notification via the MDA 132 when the viewer has closed the presentation, and if the viewer has left a comment on the presentation. For example, the server 110 may send an initial push notification to the MDA 132 when the viewer 160A accesses the presentation link for the first time. The first push notification may read “John Doe has viewed your presentation,” and in some embodiments, does not contain any further information for clarity. Additionally or alternatively, if the presenter 140 selects the push notification (e.g., by tapping on the notification on the MCD 130), the MDA 132 shows to the presenter 140 an analytic report (more details of which are described below). In some embodiments, the analytic report is not contained in the push notification to avoid clustering too much information.

In one implementation, a second push notification may be sent from the server 110 after a predetermined amount of time after to server as a reminder to the presenter 140. The second push notification may contain the same or similar messages as the first push notification. Further, in an additional embodiment, a third push notification that the MDA 132 may send is when the viewer 160A chooses to leave feedback comments on the presentation. For one instance, the third notification may read “John Doe has provided feedback on Presentation X,” and when the presenter 140 selects (e.g., by tapping on) the push notification, the MDA 132 enables the presenter 140 to read the feedback, and optionally, to read the analytic report about the presentation. In some embodiments, a summary push notification may be sent instead of or in addition to the series of push notifications. The summary push notification may include time that the viewer 160A spent on each slide of the presentation, and additionally, a total time spent by the viewer 160A on viewing the presentation. Additionally or alternatively, the presentation server 110 sends the push notifications when the server 110 is operating in the asynchronous presentation mode, and if the presentation server 110 is operating in a synchronous presentation mode, the server 110 stores the data resulting from the tracking into a memory component (e.g., repository 111) of the presentation server 110 without sending the first push notification to the MDA 132. In one example, the MDA 132 only receives in the asynchronous presentation mode when the viewer 160A is accessing the link that was sent to the viewer 160A by the presenter user 140, and the MDA 132 and/or the server 110 are configured not to receive/send push notifications in the synchronous presentation mode, or “live presentation” mode, to avoid possible interruption during a presentation. In some embodiments, the MDA 132 and/or the server 110 do not collect data or convey (e.g., via a push notification) any information during the synchronous presentation mode.

Depending on the embodiments, either the MDA 132 or the server 110 can also provide other functionality. For example, the presenter 140 can access composite analytic data for a presentation stored at the presentation server 110 to compare a particular viewer's viewing data to other viewers' data. In some embodiments, the push notification may include an analytic report of the viewer 160A's access. More precisely, the presentation server 110 can also record access of the presentation by another or other viewer(s) (e.g., viewer 160N), and the server 110 compares the viewer 160A's access data with the viewer 160N's access data to generate the analytic report.

Some embodiments provide that the presenter 140 can also access the comments left by a particular viewer or by all viewers for a particular presentation on the server 110 via the MDA 132. In some additional or alternative embodiments, the push notification includes the comments.

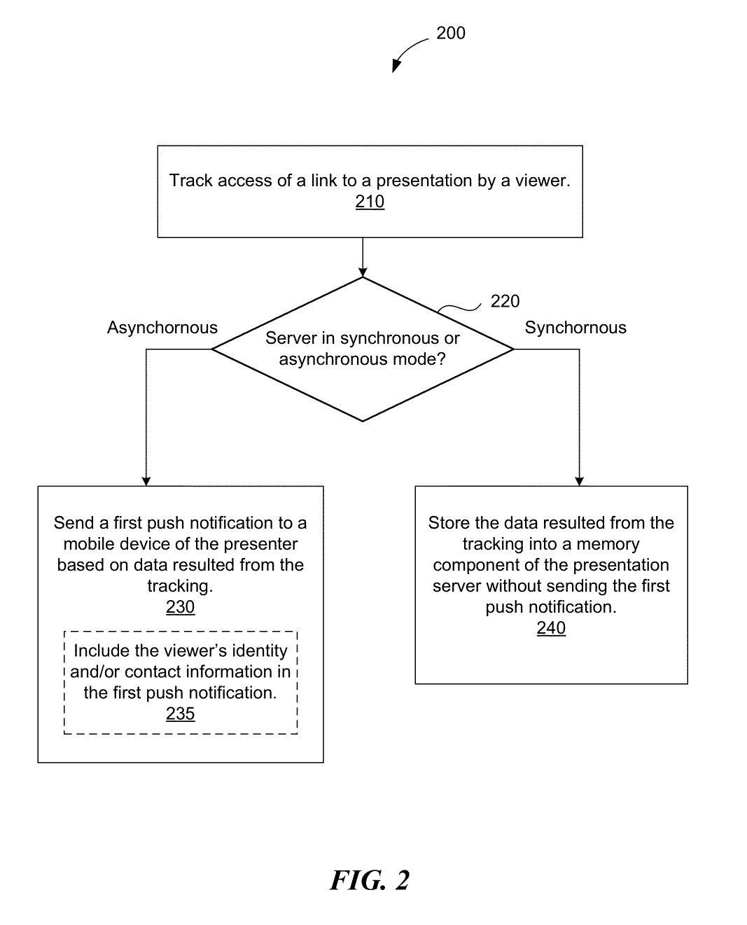

FIG. 2 depicts a flowchart illustrating an example process 200 of delivering notifications for viewers' access to presentations from a presentation server to a mobile device. For example, a sales person (e.g., a presenter) sends a potential customer audience (e.g., a viewer) an emailed link (e.g., an URL link) for accessing a presentation that is stored on a presentation server and associated with the presenter.

First, with reference to FIG. 1A, when the viewer (e.g., viewer 160A, FIG. 1A) accesses the link via a network (e.g., network 150, FIG. 1A), a presentation server (e.g., server 110, FIG. 1A) tracks (210) the access. Then, the server 110 verifies (220) its operating mode. If the server 110 is operating in an asynchronous mode, then the server 110 sends (230) a first push notification to a mobile device (e.g., via MDA 132 on MCD 130, FIG. 1A) of the presenter (e.g., presenter 140, FIG. 1A) based on data resulting from the tracking. In some embodiments, the server 110 includes (235) the viewer 160A's identity and/or contact information in the first push notification. In one or more embodiments, the server 110 sends subsequent push notifications to the MDA 132 when the viewer 160A accesses each slide of the presentation. In some embodiments, the server 110 sends a close push notification to the MDA 132 when the viewer 160A closes the presentation. In some additional embodiments, the notification includes an analytic report, and the server 110 compares the viewer 160A's data resulting from the tracking to another or other viewers' data (e.g., of viewer 160N, FIG. 1A) to generate the analytic report.

If the server 110 is operating in an synchronous mode, then the server 110 stores (240) the data resulting from the tracking into a memory component (e.g., repository 111, FIG. 1A) of the presentation server 110 without sending the first push notification to the MDA 132 on MCD 130.

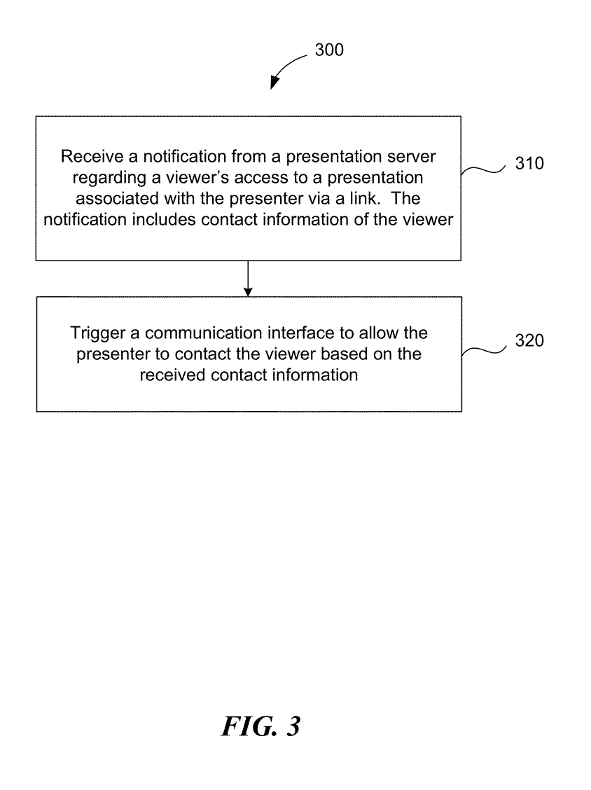

FIG. 3 depicts a flowchart illustrating an example process 300 of receiving notifications for viewers' access to presentations from a presentation server to a mobile device

Continuing with the example above with regard to FIG. 2 and with additional reference to FIG. 1B, the MDA 132 on MCD 130 of the presenter 140 receives (310) a notification from a presentation server regarding a viewer's access to a presentation associated with the presenter via a link. The notification includes contact information of the viewer 160A. Then, based on the received contact information, the MDA 132 triggers (320) a communication interface (e.g., a telephone, an email, or a text message interface) to allow the presenter 140 to contact the viewer 160A to follow up.

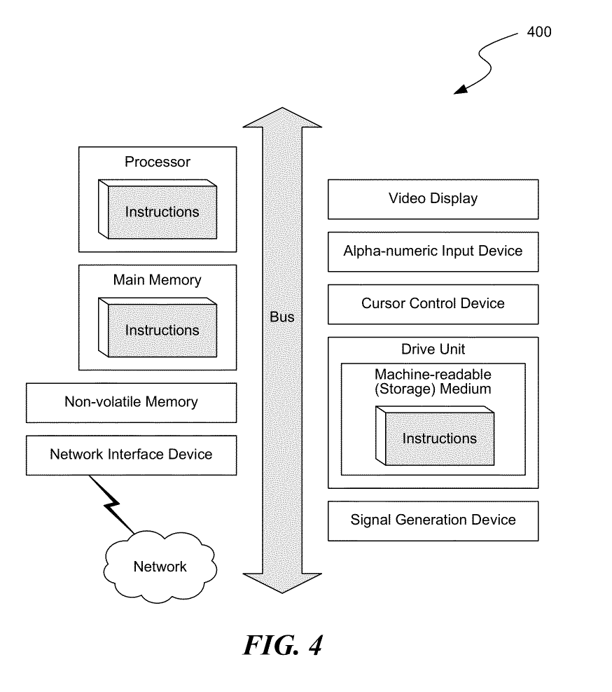

FIG. 4 shows a diagrammatic representation of a machine 400 in the example form of a mobile computer system within which a set of instructions, for causing the machine to perform any one or more of the methodologies discussed herein, may be executed

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 1300 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

What is claimed is:

1. A computer-implemented method for delivering notifications for viewers' access to presentations, the method comprising:
tracking, by a presentation server, access of a link to a presentation by a viewer, wherein the presentation is stored on the presentation server and associated with a presenter; and
sending a first push notification to a mobile device of the presenter based on data resulting from the tracking.

2. The method of claim 1, wherein the sending is performed if the presentation server is operating in a first mode, the method further comprising:
if the presentation server is operating in a second mode, storing the data resulting from the tracking into a memory component of the presentation server without sending the first push notification.

3. The method of claim 1, wherein the first push notification is triggered by the viewer accessing the link.

4. The method of claim 3, further comprising:
sending a subsequent push notification to the mobile device when the viewer accesses each slide of the presentation.

5. The method of claim 3, further comprising:
sending a close push notification to the mobile device when the viewer closes the presentation.

6. The method of claim 1, wherein the first push notification includes the viewer's identity.

7. The method of claim 1, wherein the first push notification includes the viewer's contact information.

8. The method of claim 1, wherein the first push notification includes time that the viewer spends on each slide of the presentation and a total time spent on the presentation.

9. The method of claim 1, wherein the first push notification includes an analytic report of the viewer's access, the method further comprising:
comparing the viewer's data resulting from the tracking to other viewers' data to generate the analytic report.

10. The method of claim 1, wherein the first push notification includes one or more comments left by the viewer.

11. A method for receiving notifications for viewers' access to presentations, the method comprising:
receiving, on a mobile device of a presenter, a notification from a presentation server regarding a viewer's access to a presentation associated with the presenter via a link, wherein the presentation is stored on the presentation server, and wherein the notification is triggered by the viewer accessing the link and includes contact information of the viewer; and
triggering, on the mobile device, a communication interface to allow the presenter to contact the viewer based on the received contact information.

12. The method of claim 11, wherein the notification further includes time that the viewer spends on each slide of the presentation and a total time spent on the presentation.

13. The method of claim 11, wherein the notification includes an analytic report of the viewer's access, the method further comprising:
receiving other viewers' data from the presentation server; and
comparing the viewer's data resulting from the tracking to the received other viewers' data to generate the analytic report.

14. The method of claim 11, wherein the notification includes one or more comments left by the viewer.

15. A system for delivering notifications for viewers' access to presentations, the system comprising:
a processor; and
a memory component coupled to the processor and storing a plurality of instructions which, when executed by the processor, cause the processor to:
track access of a link to a presentation by a viewer, wherein the presentation is stored on the presentation server and associated with a presenter; and
send a first push notification to a mobile device of the presenter based on data resulting from the tracking.

16. The system of claim 15, wherein the processor is to send the first push notification if the system is operating in a first mode, and wherein the instructions further cause the processor to:
if the system is operating in a second mode, store the data resulting from the tracking into the memory component of the system without sending the first push notification.

17. The system of claim 15, wherein the first push notification is triggered by the viewer accessing the link.

18. The system of claim 17, wherein the instructions further cause the processor to:
send a subsequent push notification to the mobile device when the viewer accesses each slide of the presentation.

19. The system of claim 17, wherein the instructions further cause the processor to:
send a close push notification to the mobile device when the viewer closes the presentation.

20. The system of claim 15, wherein the first push notification includes the viewer's identity and the viewer's contact information.

21. The system of claim 15, wherein the first push notification includes time that the viewer spends on each slide of the presentation and a total time spent on the presentation.

22. The system of claim 15, wherein the first push notification includes an analytic report of the viewer's access, and wherein the instructions further cause the processor to:
compare the viewer's data resulting from the tracking to other viewers' data to generate the analytic report.

23. The system of claim 15, wherein the first push notification includes one or more comments left by the viewer.

24. A system for delivering notifications for viewers' access to presentations, the system comprising:
means for tracking, by the system, access of a link to a presentation by a viewer, wherein the presentation is stored on the system and associated with a presenter; and
means for sending a first push notification to a mobile device of the presenter based on data resulting from the tracking.

25. A system for receiving notifications for viewers' access to presentations, the system comprising:
means for receiving, on the system, a notification from a presentation server regarding a viewer's access to a presentation associated with the presenter via a link, wherein the presentation is stored on the presentation server, and wherein the notification is triggered by the viewer accessing the link and includes contact information of the viewer; and
means for triggering, on the system, a communication interface to allow the presenter to contact the viewer based on the received contact information.
